(19) United States
(12) Patent Application Publication
(10) Pub. No.: US 2021/0352214 A1
(43) Pub. Date: Nov. 11, 2021

(54) Detection of objects

(71) Applicant: SICK AG, Waldkirch (DE)

(72) Inventors: Romain MÜLLER, Waldkirch (DE); Johannes RHEINBOLDT, Waldkirch (DE)

(21) Appl. No.: 17/313,598

(22) Filed: May 6, 2021

(30) Foreign Application Priority Data
May 7, 2020 (DE) 102020112430.9

(51) Int. Cl. H04N 5/232; G01S 17/894; G06K 7/14

(52) U.S. Cl. CPC H04N 5/232121; H04N 5/232127; G06K 7/1417; G01S 17/894; G06K 7/1413; H04N 5/23218

(57) ABSTRACT

A camera for detecting objects in a detection zone is provided that has an image sensor for recording image data of the objects, a distance sensor for detecting at least one distance value from a respective object, and a control and evaluation unit that is configured to perform at least one setting of the camera for a recording using the distance value, The control and evaluation unit here has real time capability and is configured to generate a recording at a trigger time using time information of the distance sensor.

### DETECTION OF OBJECTS

The invention relates to a camera and to a method for detecting objects in a detection zone.

Cameras are used in a variety of ways in industrial applications to automatically detect object properties, for example for the inspection or for the measurement of objects. In this respect, images of the object are recorded and are evaluated in accordance with the task by image processing methods. A further use of cameras is the reading of codes. Objects with the codes located thereon are recorded using an image sensor and the code zones are identified in the images and then decoded. Camera-based code readers also cope without problem with different code types than one-dimensional barcodes which also have a two-dimensional structure like a matrix code and provide more information. The automatic detection of the text of printed addresses, (optical character recognition, OCR) or of handwriting is also a reading of codes in principle. Typical areas of use of code readers are supermarket cash registers, automatic parcel identification, sorting of mail shipments, baggage handling at airports, and other logistic applications.

A frequent detection situation is the installation of the camera above a conveyor belt. The camera records images during the relative movement of the object stream on the conveyor belt and instigates further processing steps in dependence on the object properties acquired. Such processing steps comprise, for example, the further processing adapted to the specific object at a machine which acts on the conveyed objects or a change to the object stream in that specific objects are expelled from the object stream within the framework of a quality control or the object stream is sorted into a plurality of partial object streams. If the camera is a camera-based code reader, the objects are identified with reference to the affixed codes for a correct sorting or for similar processing steps.

The camera is frequently a part of a complex sensor system. It is, for example, customary with reading tunnels at conveyor belts to measure the geometry of the conveyed objects in advance using a separate laser scanner and to determine focus information, trigger times, image zones with objects and the like from it. A simpler trigger sensor, for instance in the form of a light grid or of a light barrier, is further known. Such external additional sensors have to be installed, parameterized, and put into operation. Information such as geometrical data and trigger signals furthermore have to be forwarded to the camera. This is conventionally done via CAN bus and the processor of the camera that is also responsible for other activities such as code reading and the like. Real time capability is not ensured here.

A camera is presented in DE 10 2018 105 301 A1 that has an integrated distance sensor. This admittedly facilitates some setup steps and the now internal communication. The problem of real time capability is, however, not looked at.

It is therefore the object of the invention to improve the adaptation of a camera to a recording situation.

This object is satisfied by a camera and by a method for detecting objects in a detection zone in accordance with the respective independent claims. The camera records image data of the objects using an image sensor. In addition to the image sensor, the camera comprises a distance sensor that measures at least one distance value for the distance between the camera and the object. A control and evaluation unit uses the distance value to perform a setting of the camera for a recording. A recording parameter is, for example, set or readjusted, an optics or lighting is adjusted, or the image sensor is put into a specific mode.

The invention starts from the basic idea of integrating the distance sensor with real time capability. The control and evaluation unit receives time information from the distance sensor and thus triggers a recording at a suitable trigger time. This can all be precisely synchronized thanks to the real time capability. The distance sensor itself is the timer and its real time capability is given in a certain manner as long as its measurements remain fast with respect to the object movements and the recording frequency of the camera; and this is not a particularly strict demand. A control and evaluation unit is used for this purpose that has real time capability at least to the extent that it requires the triggering of the recording at the trigger time and the forwarding and evaluation of distance values required for this.

The invention has the advantage that an optimum image recording is made possible. The distance values help the camera perform suitable settings. The real time capability in turn provides that the image recording is actually triggered at the correct time. The gain from a setting of the camera to match the distance values can thus be fully exploited.

The control and evaluation unit preferably has a microprocessor with real time capability connected to the distance sensor or an FPGA (field programmable gate array) connected to the distance sensor that are in particular integrated in the distance sensor. The microprocessor can in turn be connected to an FPGA or vice versa. These modules together form the control and evaluation unit having real time capability. They communicate with one another with a protocol having real time capability. Functionally, and possibly at least partially also structurally, the control and evaluation unit can be seen as belonging to the distance sensor. The camera can comprise further modules without real time capability for other control and evaluation unit functionalities.

The camera preferably has an optics with adjustable focus arranged in front of the image sensor, with the setting of the camera comprising a focus setting. One of the settings that are performed in dependence on the measured distance value is accordingly the focal position. A focused image is thus recorded at the trigger time.

The distance sensor is preferably integrated in the camera. This produces a particularly compact design with simple internal data access and a considerably simplified installation. The mutual alignment of the distance sensor and the camera is thus moreover known and fixed. The camera with its fixedly installed own distance sensor can perceive its environment autonomously.

The distance sensor is preferably an optoelectronic distance sensor, in particular in accordance with the principle of the time of flight process. This is a particularly suitable method in connection with this likewise optical detection of the camera. The distance sensor preferably has a plurality of avalanche photodiodes operable in Geiger mode. Such avalanche photodiode elements can be particularly simply activated and deactivated in that a bias voltage is applied above or below the breakdown voltage. Active zones or regions of interest of the distance measurement can thus be fixed.

The distance sensor preferably has a plurality of measurement zones for measuring a plurality of distance values. A measurement zone preferably has one or more light reception elements. Each measurement zone is able to measure a distance value so that the distance sensor acquires lateral spatial resolution and can determine a whole vertical section.

The control and evaluation unit is preferably configured to form a common distance value from the plurality of distance values. The common distance value should be representative to obtain a manageable criterion for the setting of the camera. A statistical measure such as the mean value is suitable for this, for example. Solely specific distance values from a relevant region of the distance measurement can be used as the basis for the common distance value. In a conveyor belt application, they can be those measurement zones that are directed to the respective incoming object to acquire distance values as early as possible. On a manual presentation of objects in the detection zone, measurement zones in the center preferably tend to be used. For a distance sensor that only has one measurement zone, the only distance value is automatically the common distance value.

The control and evaluation unit is preferably configured to recognize a new object when the distance value changes and then to determine a trigger time for this. The change should preferably exceed a tolerance threshold, that is should represent a certain jump. This is then evaluated as an entry of a new object for which a further trigger time is generated or on whose reaching a further image recording is generated.

The distance sensor is preferably configured to determine a remission value. The primary function of the distance sensor is the measurement of distance values. The intensity of the measurement signal can, however. also simultaneously be evaluated in this process. Specifically with Geiger mode avalanche photodiodes, events can be counted for this purpose while the times of the events are used for the time of flight measurement.

The control and evaluation unit is preferably configured to recognize a new object when the remission value changes and then to determine a trigger time for this. It is preferably primarily the distance values with reference to which the camera is set and a respective new object is recognized. However, a change of the remission value can also be used as the criterion, above all when there are now or few distance changes between two objects. In this process, a threshold evaluation is preferably carried out to only filter changes of the remission value caused by noise.

The control and evaluation unit is preferably configured to carry out the setting of the camera in accordance with a sequence of a plurality of trigger times. If objects are successively moved into the detection zone such as in a conveyor belt application, it is possible that distance values for a further object are already measured before the trigger time of an earlier object. It is then not expedient, for example, to set the focal position immediately for the new object because this does not relate to the next recording at all. The settings are instead carried out in an ordered manner after one another in accordance with the trigger times and thus where necessary, also for the example of the focal position, its adjustment is delayed until the earlier recordings have been completed.

The distance sensor is preferably configured to transmit a time stamp as the time information on a distance value or a trigger time. The time stamp is the raw time information from which a trigger point can be derived. This calculation already takes place in dependence on the embodiment in the distance sensor or only in the control and evaluation unit. Depending on the embodiment, a constant delay or, for example, a delay that is to be determined dynamically is present between the time stamp and the trigger time until the object will have moved into a desired recording position on a conveyor belt, for instance.

The camera preferably has a pulsed illumination unit, with the control and evaluation unit being configured to synchronize the trigger time with an illumination pulse. It is customary in a number of applications to illuminate the detection zone for an image recording. Instead of an individual photoflash, a regular pulse illumination is frequently used for this purpose that enables a coexistence with the environment including other camera systems. The trigger time is still slightly displaced in such a scenario so that the recording coincides with an illumination pulse. Alternatively, the illumination pulse could be displaced in time; however, this scrambles the pulse scheme, on the one hand, which the environment does not always permit and in addition the illumination unit would generally have to permit an adaptation with real time capability.

The setting of the camera preferably has an exposure time of the recording. Depending on the distance value, an overexposure or underexposure can be threatened and this can be compensated by adapting the exposure time. An illumination unit could instead also be adapted, but this again requires it to have real time capability.

The control and evaluation unit is preferably configured to read code contents of codes recorded with the objects. The camera thus becomes a camera-based code reader for barcodes and/or 2D codes according to various standards, optionally also for text recognition (optical character recognition, OCR). There are no real time demands for the decoding so that different modules can be responsible for this than the components having real time capability with which distance values are transmitted, trigger times are determined, and recordings are triggered.

The camera is preferably installed as stationary at a conveying device which conveys the objects in the direction of movement. This is a very frequent industrial application of a camera in which the objects are in a relative movement thereto. The spatial and temporal relationships between a distance measurement in one conveying position and an image recording in a later conveying position are very simple and calculable. For this purpose, only the conveying speed has to be parameterized, handed over by a higher ranking control, or measured itself, for instance using a tracking of a vertical section.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

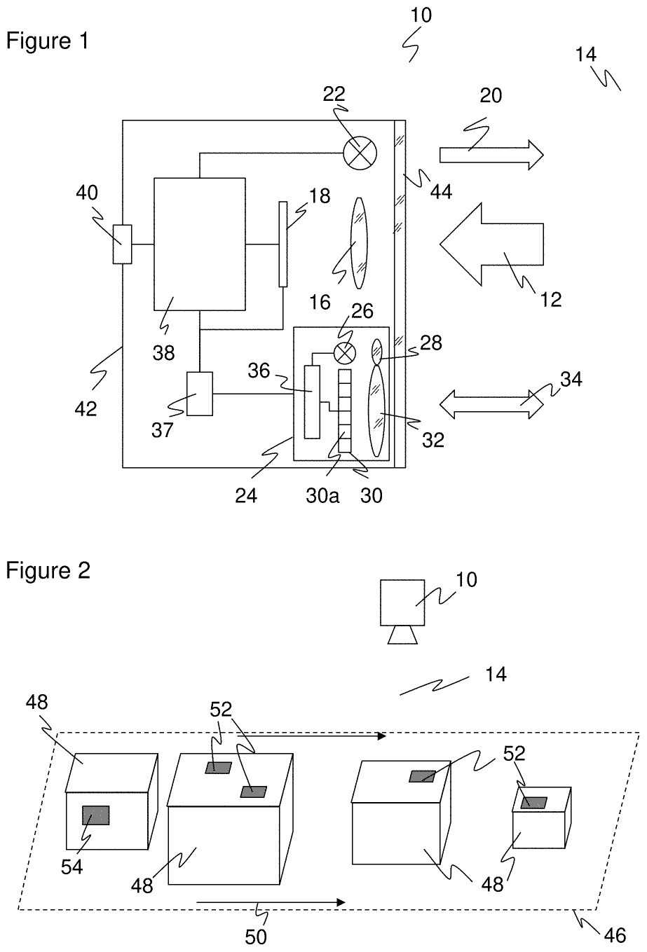

FIG. 1 a schematic sectional representation of a camera with an optoelectronic distance sensor; and

FIG. 2 a three-dimensional view of an exemplary use of the camera in an installation at a conveyor belt.

FIG. 1 shows a schematic sectional representation of a camera 10. Received light 12 from a detection zone 14 is incident on a reception optics 16 that conducts the received light 12 to an image sensor 18. The optical elements of the reception optics 16 are preferably configured as an objective composed of a plurality of lenses and other optical elements such as diaphragms, prisms, and the like, but here only represented by a lens for reasons of simplicity.

To illuminate the detection zone 14 with transmitted light 20 during a recording of the camera 10, the camera 10 comprises an optional illumination unit 22 that is shown in FIG. 1 in the form of a simple light source and without a transmission optics. In other embodiments, a plurality of light sources such as LEDs or laser diodes are arranged around the reception path, in ring form, for example, and can also be multi-color and controllable in groups or individually to adapt parameters of the illumination unit 22 such as its color, intensity, and direction.

In addition to the actual image sensor 18 for detecting image data, the camera 10 has an optoelectronic distance sensor 24 that measures distances from objects in the detection zone 14 using a time of flight (TOF) process. The distance sensor 24 comprises a TOF light transmitter 26 having a TOF transmission optics 28 and a TOF light receiver 30 having a TOF reception optics 32. A TOF light signal 34 is thus transmitted and received again. A time of flight measurement unit 36 determines the time of flight of the TOF light signal 34 and determines from this the distance from an object at which the TOF light signal 34 was reflected back.

The TOF light receiver 30 has a plurality of light reception elements 30a. The light reception elements 30a individually or in smaller groups form measurement zones with which a respective distance value is determined. No individual distance value is therefore preferably detected, although that is also possible, but the distance values are rather spatially resolved and can be assembled to form a vertical section. The number of measurement zones of the TOF light receiver 30 can remain comparatively small, for example with some tens, hundreds, or thousands of measurement zones, far remote from customary megapixel resolutions of the image sensor 18.

The design of the distance sensor 24 is purely exemplary. The optoelectronic distance measurement by means of time light processes is known and will therefore not be explained in detail. Two exemplary measurement processes are photomixing detection using a periodically modulated TOF light signal 34 and pulse time of flight measurement using a pulse modulated TOF light signal 34. There are also highly integrated solutions here in which the TOF light receiver 30 is accommodated on a common chip with the time of flight measurement unit 36 or at least parts thereof, for instance TDCs (time to digital converters) for time of flight measurements. In particular a TOF light receiver 30 is suitable for this purpose that is designed as a matrix of SPAD (single photon avalanche diode) light reception elements 30a. Measurement zones of SPAD light reception elements 30a can be directly deactivated and activated in that the bias voltage is set below or above the breakdown voltage. An active zone of the distance sensor 24 can thereby be set. The TOF optics 28, 32 are shown only symbolically as respective individual lenses representative of any desired optics such as a microlens field.

Despite its name, the distance sensor 24 is in a preferred embodiment additionally able to also measure a remission value. The intensity of the received TOF light signal 34 is evaluated for this purpose. With SPAD light reception elements 30a, the individual event is not suitable for an intensity measurement because the same maximum photocurrent is generated on registration of a photon by the uncontrolled avalanche breakdown. However, events in a plurality of SPAD light reception elements 30a of a measurement zone and/or over a longer measurement duration can indeed be counted. This is then also a measure for the intensity with SPAD light reception elements.

A control and evaluation circuit 37 having real time capability is provided for the evaluation with real time capability of the distance values of the distance sensor 24. It, for example, comprises a microprocessor or FPGA having real time capability or a combination thereof. The connection between the distance sensor 24 and the control and evaluation unit 37 having real time capability can be implemented via 120 or SPI. A connection between the microprocessor and the FPGA can take place via PCI, PCIe, MIPI, UART, or similar. The time critical processes, in particular the real time synchronization with the image recording of the image sensor 18, are controlled by the control and evaluation unit 37 having real time capability. In addition, settings of the camera 10, for instance a focal position or an exposure time, are set using the evaluation of the distance values.

A further control and evaluation unit 38 does not have to have real time capability and is connected to the illumination unit 22, to the image sensor 18, and to the control and evaluation unit 37 of the distance sensor 24. This control and evaluation unit is responsible for further control, evaluation, and other coordination work in the camera 10. It therefore reads image data of the image sensor 18 to store them and to output them at an interface 40, for example. The control and evaluation unit 38 is preferably able to localize and decode code zones in the image data so that the camera 10 becomes a camera-based code reader.

The division into a control and evaluation unit 37 having real time capability and a control and evaluation unit 38 not having real time capability in FIG. 1 should clarify the principle and is purely by way of example. The control and evaluation unit 37 having real time capability can be at least partially implemented in the distance sensor 24 or in its time of flight measurement unit 36. Functions can furthermore be shifted between the control and evaluation units 37, 38. It is only not possible in accordance with the invention that a component not having real time capability takes over time critical functions such as the determination of a trigger time for the image sensor 18.

The camera 10 is protected by a housing 42 that is terminated by a front screen 44 in the front region where the received light 12 is incident.

FIG. 2 shows a possible use of the camera 10 in an installation at a conveyor belt 46. The camera 10 is shown here only as a single symbol and no longer with its structure already explained with reference to FIG. 1. The conveyor belt 46 conveys objects 48, as indicated by a direction of movement 50 with an arrow, through the detection zone 14 of the camera 10. The objects 48 can bear code zones 52 at their outer surfaces. It is the object of the camera 10 to detect properties of the objects 48 and, in a preferred use as a code reader, to recognize the code zones 52, to read and decode the codes affixed there, and to associate them with the respective associated object 48. In order also to recognize objects, laterally applied code zones 54, additional cameras 10, not shown, are preferably used from different perspectives.

The use on a conveyor belt 46 is only an example. The camera 10 can alternatively be used for different applications, for instance at a fixed workplace at which a worker holds respective objects 48 into the detection zone.

The real time processing of distance values and the control of the image recording by the control and evaluation unit 37 will now be explained in a sequence example.

The distance sensor 24 or its time of flight measurement unit 36 already take care of converting the raw data, for example in the form of reception events, into distance values. In addition, in dependence on the embodiment, a time stamp for the time of the distance measurement of the respective distance value and a remission value are available. With a single-zone distance sensor 24, only one respective distance value is measured that cannot be further evaluated. With a plurality of measurement zones and thus distance values, a preselection of relevant measurement zones is preferably made. In a conveyor belt application as in FIG. 2, they are preferably measurement zones that detect an incoming object 48 as early as possible. Central measurement zones are more suitable in a workstation in which objects 48 are manually held into the detection zone 14. Since some settings can only be made once and not in a differentiated manner for a vertical section, the plurality of distance values are offset with one another, for example as a mean value, as in the case of a focal position.

It is mostly possible to separate objects 48 from one another with reference to the distance values. This is not always possible due to measurement errors of the distance sensor 24 and in unfavorable constellations such as objects 48 of a similar height following one another closely or with very flat objects 48 such as an envelope. The remission value can then be used as a supplementary or alternative criterion. A check can be made in a specific example whether the distance values differ from the distance from the conveyor belt 46 by more than a noise threshold. If this is the case, the distance values are the dominant feature with reference to which the focal position is set. A mean value is preferably only formed from distance values different from the distance from the conveyor belt 48 since only they belong to the appropriate object 48. If conversely all the distances within the framework of the noise threshold only measure the conveyor belt 46, a check is made whether the remission values allow a difference to be recognized to, for example, recognize a light envelope on a dark conveyor belt 46. A focal position can then be placed onto the plane of the conveyor belts 46. If there are no significant differences in either the distance or in the remission, an object 48 may be overlooked—a black envelope on a black background is not recognized, but would anyway not be able to bear any readable code 52.

In an alternative application in which objects 48 are held into the detection zone 14 by hand, it is extremely unlikely that this takes place for two successive objects 48 at the same distance without a gap. A separation of objects 48 using the distance values is therefore possible as a rule. A supplementary use of remissions values is nevertheless also conceivable here.

It is thus recognized if a new camera setting and a trigger time for a further object 48 are required. The trigger time at which the image recording takes place results from the time stamp. A fixed or a dynamically determined time offset has to be considered here. In the conveyor belt application, this is the time that the object 48 requires until it has been conveyed into the recording position, for example centrally into the detection zone 14, from the first detection by the distance sensor 24. This depends, on the one hand, on the belt speed that is known by parameterization, specification, or measurement and, on the other hand, on the object height measured over the distance values and on the geometrical arrangement. A constant time offset is sufficient in an application with a manual guidance of objects 48.

The control and evaluation unit 37 having real time capability preferably does not immediately reset the camera 10 in accordance with the last measured distance values, but rather in order only at the trigger time, naturally where possible in good time while taking account of adaptation delays. A focal position may, for example, not be adjusted immediately if another object 48 should still previously be recorded. Its distance values are then decisive initially up to its trigger time. As soon as the control and evaluation unit 37 having real time capability has determined that it is no longer necessary to wait for a previous image, the reset can begin.

The image recording generally takes place at the trigger time. If, however, the illumination time 22 is operated in a pulsed manner at a predefined frequency, the image recording should be synchronized with it. For this purpose, the image recording is synchronized to a suitable illumination pulse, that is, for example, to the next illumination pulse before or after the originally intended trigger time. In principle, it is alternatively conceivable to displace the illumination pulse. However, the illumination unit 22 must support this and in addition the pulse sequence is frequently not a free variable but rather predefined by conditions.

The focal position frequently used as an example is in no way the only conceivable camera setting. An adaptation of the exposure time in dependence on the distance value is, for example, also conceivable to avoid an overexposure or an underexposure. An adaptation of the illumination intensity would alternatively be conceivable for this. However, this requires a setting possibility having real time capability of the illumination unit 22.

On the storage or output of the image data that are detected at the trigger time, metadata such as the distance values or the trigger time can be appended. This enables further evaluations at a later time and also a diagnosis and improvement of the camera 10 and its application.

1. A camera for detecting objects in a detection zone, the camera comprising:
an image sensor for recording image data of the objects, a distance sensor for detecting at least one distance value from a respective object, and
a control and evaluation unit that is configured to perform at least one setting of the camera for a recording using the distance value,
wherein the control and evaluation unit has real time capability and is configured to generate a recording at a trigger time using time information of the distance sensor.

2. The camera in accordance with claim 1,
wherein the control and evaluation unit has one of a microprocessor having real time capability connected to the distance sensor and an FPGA connected to the distance sensor.

3. The camera in accordance with claim 2,
wherein the one of the microprocessor and the FPGA is integrated in the distance sensor.

4. The camera in accordance with claim 1,
that has a focus adjustable optics arranged in front of the image sensor, and wherein the setting of the camera comprises a focus setting.

5. The camera in accordance with claim 1,
wherein the distance sensor is integrated into the camera.

6. The camera in accordance with claim 1,
wherein the distance sensor is an optoelectronic distance sensor.

7. The camera in accordance with claim 6,
wherein the optoelectronic distance sensor is in accordance with the principle of the time of flight process.

8. The camera in accordance with claim 1,
wherein the distance sensor has a plurality of measurement zones for measuring a plurality of distance values.

9. The camera in accordance with claim 8,
wherein the control and evaluation unit is configured to form a common distance value from the plurality of distance values.

10. The camera in accordance with claim 1,
wherein the control and evaluation unit is configured to recognize a new object when the distance value changes and then to determine a trigger time for this.

11. The camera in accordance with claim 1,
wherein the distance sensor is configured to determine a remission value.

12. The camera in accordance with claim 11,
wherein the control and evaluation unit is configured to recognize a new object when the remission value changes and then to determine a trigger time for this.

13. The camera in accordance with claim 1,
wherein the control and evaluation unit is configured to carry out the setting of the camera in accordance with a sequence of a plurality of trigger times.

14. The camera in accordance with claim 1,
wherein the distance sensor is configured to transmit a time stamp as the time information on a distance value or a trigger time.

15. The camera in accordance with claim 1,
that has a pulsed illumination unit, wherein the control and evaluation unit is configured to synchronize the trigger time with an illumination pulse.

16. The camera in accordance with claim 15,
wherein the pulsed illumination unit is configured to transmit one or more of said illumination pulses.

17. The camera in accordance with claim 1,
wherein the setting of the camera comprises an exposure time of the recording.

18. The camera in accordance with claim 1,
wherein the control and evaluation unit is configured to read code contents of codes recorded with the objects.

19. The camera in accordance with claim 1,
that is installed as stationary at a conveying device which conveys the objects in the direction of movement.

20. A method of detecting objects in a detection zone, in which image data of the objects are recorded by a camera and at least one distance value from a respective object is determined by a distance sensor, wherein at least one setting of the camera for a recording is performed with reference to the distance value,
wherein a recording is generated at a trigger time using time information of the distance sensor in a processing having real time capability.
